(19) United States
(12) Patent Application Publication
(10) Pub. No.: US 2021/0032139 A1
(43) Pub. Date: Feb. 4, 2021

(54) REGULATING A MICROENVIRONMENT OF ANAEROBIC GRANULAR SLUDGE TO PROMOTE ANAEROBIC DIGESTION AND DELAY CALCIFICATION

(71) Applicant: GuangXi University, Nanning (CN)

(72) Inventors: Shuangfei Wang, Nanning (CN); Zhiwei Wang, Nanning (CN); Meiling Li, Nanning (CN); Shuangquan Yao, Nanning (CN); Jian Zhang, Nanning (CN); Jinghong Zhou, Nanning (CN); Peng Lu, Nanning (CN); HongXiang Zhu, Nanning (CN); Shuangxi Nie, Nanning (CN)

(73) Assignee: GuangXi University

(21) Appl. No.: 16/916,664

(22) Filed: Jun. 30, 2020

(30) Foreign Application Priority Data
Aug. 1, 2019 (CN) 201910705493.1

(51) Int. Cl. C02F 3/28; D21C 11/00

(52) U.S. Cl. CPC C02F 3/2866; C02F 2103/28; D21C 11/0085

(57) ABSTRACT

To promote anaerobic digestion and delay calcification, one or more signal molecules are used to regulate the microenvironment of anaerobic granular sludge. In the process of anaerobic granular sludge treatment of papermaking wastewater, AHLs (N-acyl Hyperserine Lactones) are added to papermaking wastewater before the papermaking wastewater enters the anaerobic reactor. This may occur when the proportion of microorganism in anaerobic granular sludge VSS/TSS is less than 0.6. Further, the addition of the one or more signal molecules changes the community structure of the bacteria and methanogens, promoting anaerobic digestion and delay calcification. Additionally, the microenvironment of granular sludge is regulated by adding one or more micro-signal molecules to improve the number of bacteria susceptible to calcification, improve the anaerobic digestion rate of sludge that has not been calcified, and delay the calcification rate.

### CROSS-REFERENCE TO RELATED APPLICATION

This application claims the benefit of Chinese Patent Application No. 201910705493.1, filed on Aug. 1, 2019. The subject matter thereof is hereby incorporated herein by reference in its entirety.

### FIELD

The present invention relates to light industry pulping and paper making, and more particularly, to a method that uses signal molecules for regulating a microenvironment of anaerobic granular sludge to promote anaerobic digestion and delay calcification.

### BACKGROUND

More than 60% of the raw materials of paper making in China come from wastepaper pulp every year. Wastepaper produces a large amount of high concentration organic wastewater in the process of deinking, beating, purification, and screening. The wastewater is reduced and regenerated by anaerobic granular sludge degradation.

However, due to the high content of Ca²⁺ in wastewater, in the long-term treatment process, calcium salts are deposited on the surface, inside or in the pipeline of granular sludge in the form of calcium carbonate (CaCO₃) and carboapatite (Ca₅(PO₄.CO₃)₃(OH)). A large amount of calcium salt accumulation will promote the adhesion and aggregation between anaerobic granular sludge, reduce the mass transfer efficiency, cause channeling and blocking, reduce the reactor space, and prone to failure. The large amount of calcium salt accumulation will also cause the ash content of granular sludge to increase, the active components in sludge to be phased out, the inorganic components to occupy a large amount of space in the reactor, the value of VSS/TSS (the proportion of microorganism content in sludge) is reduced, the specific methanogenic activity is reduced. As a result, the active cycle of microorganisms becomes shorter and sludge needs to be replaced regularly, which increases the operation cost and seriously affects the treatment capacity. In some cases, this may even cause the whole treatment system to collapse, when the internal or surface of granular sludge is completely calcified. The system may take 3-6 months to recover, becoming a chronic disease of high calcium wastewater treatment.

Currently, the commonly used solution to this problem is to optimize the separation of calcified sludge by sludge discharge and pretreatment. However, it should be noted that the calcification problem has not been fundamentally solved.

Therefore, a method is needed to fundamentally solve the phenomenon of granular sludge calcification, that is, the regulation of micro-environment to slow down the calcification of sludge.

### SUMMARY

Certain embodiments of the present invention may provide solutions to the problems and needs in the art that have not yet been fully identified, appreciated, or solved by current light industry pulping and paper making technologies. For example, some embodiments of the present invention pertain to a method of using one or more signal molecules to regulate a microenvironment of an anaerobic granular sludge, promoting anaerobic digestion and delay calcification.

In an embodiment, a method of regulating a micro-environment of anaerobic granular sludge to promote anaerobic digestion and delay calcification includes facilitating entrance of papermaking wastewater into an anaerobic reactor after passing through a regulating tank. The method also includes adding one or more AHLs (N-acyl Hyperserine Lactones) signal molecules to the papermaking wastewater at an end outlet of the regulating tank, when a proportion of microorganism content in an anaerobic granular sludge in the anaerobic reactor is less than 0.6.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a method of using one or more signal molecules for the regulating of the micro-environment of anaerobic granular sludge to promote anaerobic digestion and delay calcification, according to an embodiment of the present invention.

FIG. 2 is a graph illustrating a change of COD removal rate with C8-HSL addition, according to an embodiment of the present invention.

FIG. 3 is a graph illustrating a change of specific methanogenic activity (SMA) with the addition of C8-HSL, according to an embodiment of the present invention.

FIG. 4 is a graph illustrating a change of coenzyme F₄₂₀ content with C8-HSL addition, according to an embodiment of the present invention.

FIG. 5 is a graph illustrating a change of VSS/TSS with C8-HSL addition, according to an embodiment of the present invention, according to an embodiment of the present invention.

### DETAILED DESCRIPTION OF THE EMBODIMENTS

Some embodiments of the present invention pertain to a method that uses one or more signal molecules for regulating a microenvironment of an anaerobic granular sludge, promoting anaerobic digestion and delay calcification. One of the advantages of using one or more signal molecules, which are a kind of metabolites synthesized by microorganisms, is the regulation of gene expression and activation of social behaviors (such as symbiosis) of microbial populations in the same bacteria or between different bacteria. Furthermore, the one or more signal molecules may regulate the micro-environment by adding a small amount of signal molecules.

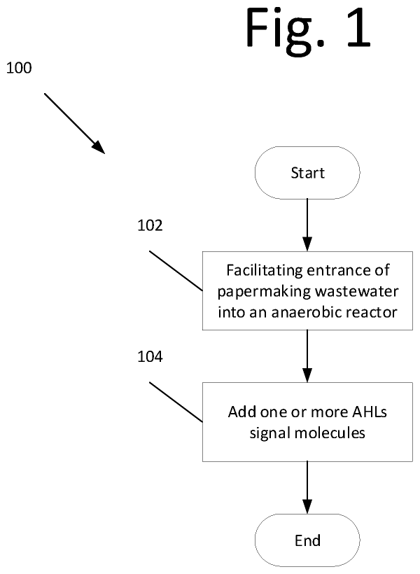

FIG. 1 is a flow diagram illustrating a method 100 of using one or more signal molecules for the regulating of the micro-environment of anaerobic granular sludge to promote anaerobic digestion and delay calcification, according to an embodiment of the present invention. In some embodiments, method 100 begins at 602 with facilitating entrance of papermaking wastewater into an anaerobic reactor after passing through a regulating tank. At 604, one or more AHLs signal molecules are added to the papermaking wastewater at an end outlet of the regulating tank, when a proportion of microorganism content in an anaerobic granular sludge in the anaerobic reactor is less than 0.6.

In some embodiments, the amount is 10-100 mg AHLs signal molecules for 1 m³ of papermaking wastewater.

In some further embodiments, the method also includes facilitating the entrance of the papermaking wastewater, which is well modulated in the regulating tank, into the anaerobic reactor.

In some additional embodiments, the method includes adding a time interval of the one or more AHLs signal molecules, which may be controlled by a time controller, and detecting, by equipping the regulating pool with a liquid level transmitter, the liquid level to prevent the feed pump of the anaerobic reactor from idling.

The beneficial effect of the embodiments is to increase the number of bacteria susceptible to calcification by adding a small amount of one or more signal molecules, so as to improve the anaerobic digestion rate of sludge that has not been calcified yet and delay the calcification rate.

### Implementation Embodiment 1

In some embodiments, the method uses one or more signal molecules for regulating the microenvironment of anaerobic granular sludge, promoting anaerobic digestion and delay calcification. In this embodiment, the experiment is carried out under laboratory conditions, and the specific operation is as follows.

Domestication

First, 50 mL of anaerobic granular sludge and 200 mL of papermaking wastewater collected from a paper mill were placed in a 250 mL anaerobic serum bottle. The bioreactor used in this example involves a 24-hour operation cycle, which has a reaction stage (23.5 h) and a sludge settling stage (0.5 h).

Next, 50 mL of supernatant is removed from the top of the anaerobic serum bottle, and the same volume of fresh papermaking wastewater with N-octyl hypererine lactone (C8-HSL) is injected into the bottle through a long syringe at the end of the cycle. The injected wastewater is then domesticated for about a week.

Sample Addition

2 μg C8-HSL standards are added to the reactor every day after domestication.

Treatment

The reactor is treated in a constant temperature magnetic stirring water bath at 38° C.

Sampling

Water samples are collected at the beginning and end of each cycle from the reactor, and sludge samples are also collected at the end of each cycle from the reactor. After a total of three months of operation, sludge biomass is collected by centrifugation at 5000×g for 10 minutes and then frozen for further sequencing analysis.

After three months, the chemical oxygen demand (COD) removal rate of this example was 75%, the specific methanogenic activity (SMA) was 25 mL/(gVSS·h), the content of coenzyme F₄₂₀ (a method to evaluate the potential methanogenic activity) was 0.18 μmol/gVSS, and the VSS/TSS was 0.65.

Compared with the reactor without exogenous signal molecules, the removal rate of COD increased by 10.8%, the specific methanogenic activity (SMA) increased by 32.4%, the activity of coenzyme F₄₂₀ increased by 33.5%, and VSS/TSS increased by 0.03. The dominant genera of bacteria in microorganisms have changed from Spirochaetaceae_uncultured, Lineage_I_Endomicrobia_norank and PL-11B10_norank to Spirochaetaceaeae_uncultured, Lactivibrio and Bacteroidetes_vadinHA17_norank, and Spirochaetaceaeae_uncultured has increased on the original basis. Furthermore, the main ecological function of Spirochaetaceae_uncultured and Lactivibrio is to degrade carbohydrates and organic acids as precursors of methanogens. Methanobactium, Methanosaeta and Methanosarcina have been enhanced. For example, Methanosaeta, AHL-mediated QS systems in Methanosaeta harundinacea 6Ac are used to regulate cell assembly and carbon metabolism fluxes that facilitate conversion of acetic acid into methane.

### Implementation Embodiment 2

In some embodiments, the method uses one or more signal molecules FOR regulating the microenvironment of anaerobic granular sludge to promote anaerobic digestion and delay calcification. In this embodiment, the experiment is carried out under laboratory conditions, and the specific operation is as follows.

Domestication

First, 50 mL of anaerobic granular sludge and 200 mL of papermaking wastewater collected from a paper mill were placed in a 250 mL anaerobic serum bottle. Next, 50 mL of supernatant is removed from the bottle, and the same volume of fresh papermaking wastewater with C8-HSL is injected therein through a long syringe at the end of the cycle, and is domesticated for about a week.

Sample Addition

20 μg C8-HSL standards are added to the reactor every day after domestication.

Treatment

The reactor is treated in a constant temperature magnetic stirring water bath, which is set to 38° C.

Sampling

Water samples are collected at the beginning and end of each cycle from the reactor, and sludge samples are also collected at the end of each cycle from the reactor. After a total of three months of operation, sludge biomass is collected by centrifugation at 5000×g for 10 minutes and then frozen for further sequencing analysis.

After three months, the COD removal rate of this example was 80%, the specific methanogenic activity (SMA) was 27 mL/(gVSS·h), the content of coenzyme F₄₂₀ (a method to evaluate the potential methanogenic activity) was 0.20 μmol/gVSS, and the VSS/TSS was 0.71.

Compared with the reactor without exogenous signal molecules, the removal rate of COD increased by 18.2%, the specific methanogenic activity (SMA) increased by 43%, the activity of coenzyme F₄₂₀ increased by 48.1%, and VSS/TSS increased by 0.09.

The dominant genera of bacteria in microorganisms have changed from Spirochaetaceae_uncultured, Lineage_I_Endomicrobia_norank and PL-11B10_norank to Spirochaetaceaeae_uncultured, Lactivibrio and Bacteroidetes_vadinHA17_norank. Further, Spirochaetaceaeae_uncultured has increased on the original basis; moreover, Spirochaetaceae_uncultured, Lactivibrio are main ecological function is to degrade carbohydrates and organic acids as precursors of methanogens.

Methanobactium, Methanosaeta and Methanosarcina have been enhanced; especially Methanosaeta, AHL-mediated QS systems in Methanosaeta harundinacea 6Ac are used to regulate cell assembly and carbon metabolism fluxes that facilitate conversion of acetic acid into methane.

### Implementation Embodiment 3

In some embodiments, the method uses signal molecules for regulating the microenvironment of anaerobic granular sludge to promote anaerobic digestion and delay calcification. The experiment in this embodiment is carried out under paper mill conditions, and the specific operation is as follows.

In an anaerobic reactor of a paper mill, the reactor is 8 m high and its working volume is 1500 m³. The papermaking wastewater with high calcium content enters into a regulating tank. The regulating tank has a volume of 1000 m³. When it is detected that the proportion of microorganism content in the anaerobic granular sludge in the anaerobic reactor is less than 0.6, C8-HSL standard of AHLs type signal molecule is added to the paper-making wastewater at the outlet of the regulating tank end, the quantity of C8-HSL standard is 50 mg per cubic meter of papermaking wastewater. The time interval of signal molecule input is controlled by time controller. The regulating pool is equipped with liquid level transmitter to detect the liquid level to prevent the reactor feed pump from idling. The wastewater that is modulated in the regulating tank is injected into the anaerobic reactor through the wastewater feed pump and treated according to the conventional anaerobic way. In the treatment process, water samples are collected once a month, and sludge samples are collected once half a year. Sludge biomass is collected by centrifugation at 5000×g for 10 minutes, and then frozen for further sequencing analysis.

In this example, after five years, the COD removal rate was 75%, the specific methanogenic activity (SMA) was 24 mL/(gVSS·h), the content of coenzyme F₄₂₀ was 0.19 μmol/gVSS, and VSS/TSS was 0.67.

According to the measured data, the sludge has not been calcified. However, when signal molecule C8-HSL is not added before, the anaerobic granular sludge in the plant appears to have obvious calcification for up to two years, the number of methanogens decreases significantly, and the effect of signal molecule C8-HSL on delaying calcification becomes obvious.

The dominant genera of bacteria in microorganisms also changes from Spirochaetaceae_uncultured, Lineage_I_Endomicrobia_norank and PL-11B10_norank to Spirochaetaceaeae_uncultured, Lactivibrio and Bacteroidetes_vadinHA17_norank. Further, Spirochaetaceaeae_uncultured increases on the original basis, and moreover, Spirochaetaceae_uncultured, Lactivibrio has an ecological function of degrading carbohydrates and organic acids as precursors of methanogens. Additionally, Methanobactium, Methanosaeta and Methanosarcina are enhanced, especially Methanosaeta, AHL-mediated QS systems in Methanosaeta harundinacea 6Ac are used to regulate cell assembly and carbon metabolism fluxes that facilitate conversion of acetic acid into methane.

### Contrast Embodiment 1

Different from implementation embodiment 2, C8-HSL standard is not added to the proportion, and the specific operation is as follows.

Domestication

50 mL of anaerobic granular sludge and 200 mL of papermaking wastewater, both of which were collected from a papermill, were placed in a 250 mL anaerobic serum bottle. The bioreactor involves a 24-hour operation cycle, which has a reaction stage (23.5 h) and a sludge settling stage (0.5 h).

50 mL of supernatant is removed from the top of the anaerobic serum bottle, and the same volume of fresh papermaking wastewater with distilled water is injected into the bottle through a long syringe at the end of the cycle and is domesticated for about a week.

Sample Addition

20 μg distilled water is added to the reactor every day after domestication.

Treatment

The reactor is treated in a constant temperature magnetic stirring water bath at 38° C.

Sampling

Water samples are collected at the beginning and end of each cycle from the reactor, and sludge samples are also collected at the end of each cycle from the reactor. After a total of three months of operation, sludge biomass was collected by centrifugation at 5000×g for 10 minutes and then frozen for further sequencing analysis.

After three months, the removal rate of COD was 67.69%, specific methanogenic activity (SMA) was 18.88 mL/(gVSS·h), coenzyme F₄₂₀ (a method to evaluate the potential methanogenic activity) was 0.135 μmol/gVSS, and VSS/TSS was 0.62. The dominant bacteria in the microbial community were Spirochaetaceae_uncultured, Lineage_I_Endomicrobia_norank and PL-11B10_norank.

### Contrast Embodiment 2

Different from the example shown above (see Example 2), the dosage of C8-HSL standard is 150 mg/m³. The specific operation is as follows.

Domestication

50 mL of anaerobic granular sludge and 200 mL of papermaking wastewater, both of which were collected from a papermill, were placed in a 250 mL anaerobic serum bottle. The bioreactor involves a 24-hour operation cycle, which has a reaction stage (23.5 h) and a sludge settling stage (0.5 h). 50 mL of supernatant is removed from the top of the anaerobic serum bottle, and the same volume of fresh papermaking wastewater with C8-HSL is injected into the bottle through a long syringe at the end of the cycle, and the injected wastewater is then domesticated for about a week.

Sample Addition

30 μg C8-HSL standards are added to the reactor every day after domestication.

Treatment

The reactor is treated in a constant temperature magnetic stirring water bath at 38° C.

Sampling

Water samples are collected at the beginning and end of each cycle from the reactor, and sludge samples are also collected at the end of each cycle from the reactor. After a total of three months of operation, sludge biomass was collected by centrifugation at 5000×g for 10 minutes and then frozen for further sequencing analysis.

After three months, the COD removal rate of this example was 80.3%, the specific methanogenic activity (SMA) was 27.5 mL/(gVSS·h), the content of coenzyme F₄₂₀ (a method to evaluate the potential methanogenic activity) was 0.203 μmol/gVSS, and the VSS/TSS was 0.72.

Compared with the reactor without exogenous signal molecules, the removal rate of COD increased by 18.63%, the specific methanogenic activity (SMA) increased by 45.66%, the activity of coenzyme F₄₂₀ increased by 50.38%, and VSS/TSS increased by 0.1.

Further, compared with the reactor of adding 100 mg signal molecule per cubic meter of papermaking wastewater, the removal rate of COD increased by 0.375%, the specific methanogenic activity (SMA) increased by 1.85%, the activity of coenzyme F₄₂₀ increased by 1.5%, and VSS/TSS increased by 0.01, the growth trend has been slowed down. The dominant genera of bacteria in microorganisms changed from Spirochaetaceae_uncultured, Lineage_I_Endomicrobia_norank and PL-11B10_norank to Spirochaetaceaeae_uncultured, Lactivibrio and Bacteroidetes_vadinHA17_norank.

Further, Spirochaetaceaeae_uncultured increased on the original basis, and moreover, Spirochaetaceae_uncultured, Lactivibrio are main ecological function, which is to degrade carbohydrates and organic acids as precursors of methanogens. Methanobactium, Methanosaeta and Methanosarcina have been enhanced, especially Methanosaeta, AHL-mediated QS systems in Methanosaeta harundinacea 6Ac are used to regulate cell assembly and carbon metabolism fluxes that facilitate conversion of acetic acid into methane.

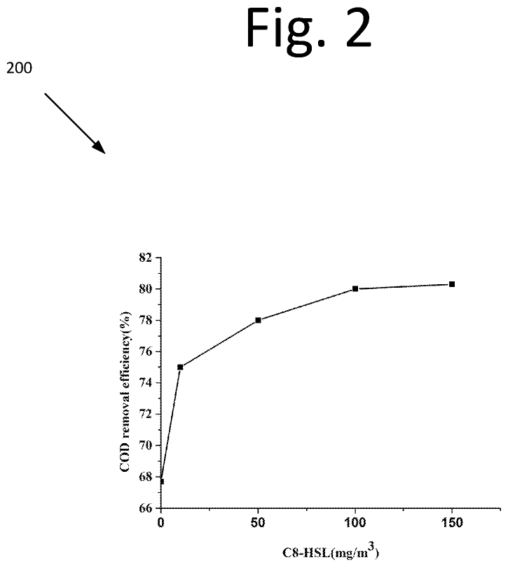

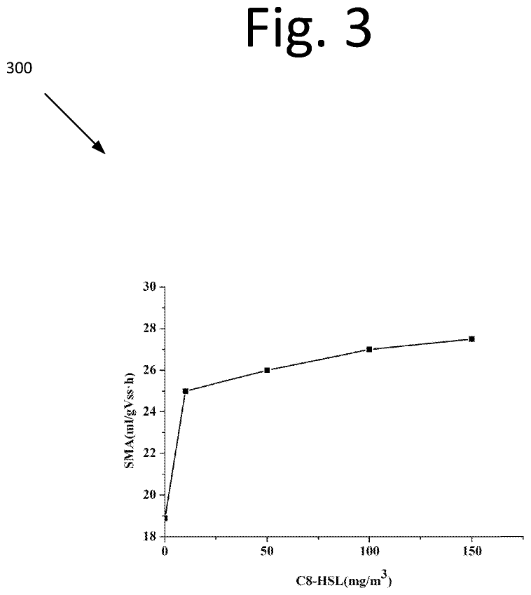

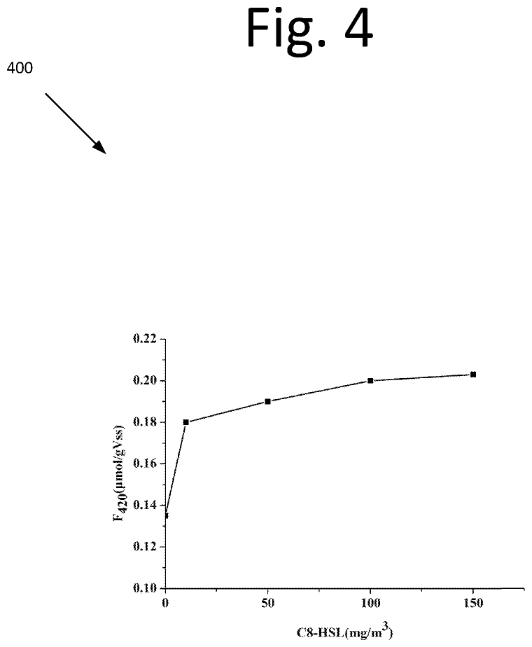

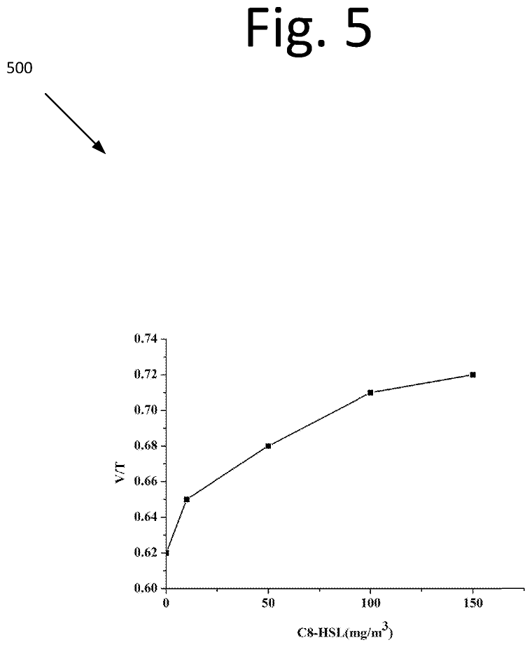

According to graphs 200-500 of FIGS. 2-5, implementation embodiments 1 and 3 and contrast embodiments 1 and 2, adding exogenous signal molecules greatly improves the anaerobic digestion rate of anaerobic granular sludge, but adding different amounts of exogenous signal molecules promotes different degrees, e.g., the optimal adding range is 10-100 mg/m³. Further, adding of the AHLs exogenous signal molecules can effectively delay calcification.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method of regulating a micro-environment of anaerobic granular sludge to promote anaerobic digestion and delay calcification, the method comprising:
facilitating entrance of papermaking wastewater into an anaerobic reactor after passing through a regulating tank; and
adding one or more AHLs signal molecules to the papermaking wastewater at an end outlet of the regulating tank, when a proportion of microorganism content in an anaerobic granular sludge in the anaerobic reactor is less than 0.6.

2. The method according to claim 1, wherein the adding of the one or more AHLs signal molecules comprises
adding 10-100 mg of the one or more AHLs signal molecules for every 1 m³ of the papermaking wastewater.

3. The method according to claim 1, wherein the one or more AHLs signal molecules are comprised of C8-HSL, C6-HSL, 3-oxo-C6-HSL or 3-oxo-C8-HSL.

4. The method according to claim 3, wherein the one or more AHLs signal molecules comprises C8-HSL.

5. The method according to claim 1, further comprising:
adding a time interval for the one or more AHLs signal molecules;
controlling the one or more AHLs signal molecules by a time controller; and
detecting, by a liquid level transmitter inside of a regulating tank, a liquid level to prevent a feed pump of the anaerobic reactor from idling.

6. A method, comprising:
facilitating entrance of papermaking wastewater into an anaerobic reactor after passing through a regulating tank; and
when the proportion of microorganism content in an anaerobic granular sludge in the anaerobic reactor is less than 0.6, adding one or more AHLs signal molecules to the papermaking wastewater at an end outlet of the regulating tank, wherein the one or more AHLs signal molecules is 10-100 mg for every 1 m³ of papermaking wastewater.

7. The method of claim 6, wherein the papermaking wastewater is modulated in the regulating tank.

8. The method of claim 7, further comprising:
adding a time interval of the one or more AHLs signal molecules and the one or more AHLs signal molecules are controlled by a time controller, and
equipping a regulating tank with a liquid level transmitter to detect a liquid level to prevent a feed pump of the anaerobic reactor from idling.
